(19) United States
(12) Patent Application Publication
(10) Pub. No.: US 2026/0330578 A1
(43) Pub. Date: Oct. 22, 2026

(54) MULTI-PARTY, STATE-SYNCHRONIZED CONFLICT RESOLUTION AND MEDIATION

(71) Applicant: Better Parenting Plan, Inc., Alamo, CA (US)

(72) Inventors: Olga Mack, Alamo, CA (US); Gabrielle Hartley, Florence, MA (US); Manmay Nakhashi, Vadodara (IN); Devansh Raj, Vadodara (IN); Parth Ashok Chawla, Vadodara (IN)

(21) Appl. No.: 19/553,253

(22) Filed: Feb. 28, 2026

Related U.S. Application Data
(60) Provisional application No. 63/784,830, filed on Apr. 7, 2025.

(51) Int. Cl. G06Q 50/18; G06Q 10/101

(52) U.S. Cl. CPC G06Q 50/188; G06Q 10/101

(57) ABSTRACT

In some embodiments, a method, apparatus and computer program for multi-party conflict resolution is disclosed. The apparatus includes a processor, a memory storing executable instructions, a plurality of participant session instances, a unified structured state repository, a cross-session synchronization engine configured to selectively synchronize structured representations between the plurality of participant session, an identity-aware routing engine configured to route communications and system-generated responses based on participant identity and assigned role, and a mediation state machine. The apparatus enables formation of agreements between the distinct participants without at times requiring direct participant-to-participant communication.

### CROSS-REFERENCE TO RELATED APPLICATIONS

This application claims the benefit of priority to U.S. Provisional Patent Application No. 63/784,830, filed on Apr. 7, 2025, the contents of which are hereby incorporated by reference.

### FIELD OF THE DISCLOSURE

The present disclosure relates generally to computer-implemented systems for structured multi-party communication and coordinated agreement formation. Some embodiments pertain to a system and method for an identity-aware, state-synchronized conflict resolution architecture in which multiple participants communicate through separate session instances while a mediation engine maintains a unified but selectively synchronized state.

### BACKGROUND

Digital communication systems are generally designed for either fully shared interaction or fully isolated interaction. In shared group communication environments, all participants view all communications in a common stream. While such systems promote transparency, they are poorly suited to conflict resolution scenarios in which direct exposure to opposing communications may escalate tension, reinforce adversarial framing, or discourage candid disclosure.

Alternatively, bilateral or isolated session systems permit participants to communicate independently. However, these systems lack coordinated awareness across participants and do not provide a structured mechanism for reconciling differing positions into enforceable outcomes. Without centralized synchronization, isolated sessions fail to support structured mediation processes that require controlled comparison of participant positions and progressive issue resolution.

Mediated conflict resolution presents unique technical challenges. Participants often require individualized engagement and role-aware interaction. A mediator must maintain structured awareness of multiple perspectives simultaneously while preventing uncontrolled direct exchange. In addition, agreements must be formed through deliberate, staged progression rather than adversarial negotiation dynamics. Traditional digital communication platforms are not architected to enforce these structural requirements.

Conventional conversational artificial intelligence systems are typically designed for single-user interaction and lack mechanisms for coordinated cross-session state management. They do not maintain synchronized structured representations across multiple isolated communication streams. They generally lack identity-aware routing that distinguishes participant roles within a mediated context. They do not implement structured agreement gating that requires explicit multi-party confirmation prior to outcome formation. Nor do they support version-controlled agreement objects capable of structured revision and auditability.

As a result, existing systems do not adequately enable structured, multi-party conflict resolution in environments where direct communication is undesirable or counterproductive. There remains a need for a computer-implemented system that facilitates mediated synchronization of independent communication streams while maintaining identity awareness, controlled state progression, structured agreement formation, and persistent version control.

### SUMMARY

Some embodiments provide a computer-implemented, multi-party conflict resolution system configured to facilitate structured agreement formation between distinct participants without requiring direct participant-to-participant communication. The system includes a processor, a memory storing executable instructions, a plurality of participant session instances, a unified structured state repository, a cross-session synchronization engine configured to selectively synchronize structured representations between the plurality of participant session, an identity-aware routing engine configured to route communications and system-generated responses based on participant identity and assigned role, and a mediation state machine. The apparatus enables formation of agreements between the distinct participants without at times requiring direct participant-to-participant communication.

The system may be adaptable to a wide range of dispute-resolution contexts, including legal mediation, financial structuring, workplace disputes, commercial negotiations, therapeutic communication, governmental proceedings, and other structured conflict environments.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate example embodiments disclosed herein and explain various principles and advantages of those embodiments.

FIG. 1 illustrates a method for multi-party, state-synchronized conflict resolution, in accordance with some example embodiments;

FIG. 2 depicts a mediation state machine in accordance with some example embodiments;

FIG. 3 illustrates a cross-session synchronization engine in accordance with some example embodiments;

FIG. 4 depicts a dual consent verification system in accordance with some example embodiments;

FIG. 5 illustrates a system for multi-party, state-synchronized conflict resolution with revision and versioning, in accordance with some example embodiments;

FIG. 6 depicts an apparatus for multi-party, state-synchronized conflict resolution with optional revision and versioning, in accordance with some example embodiments; and

FIG. 7 illustrates a method for multi-party, state-synchronized conflict resolution with optional de-escalation and jurisdiction-aware computation modules along with an optional multimodal interface layer.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

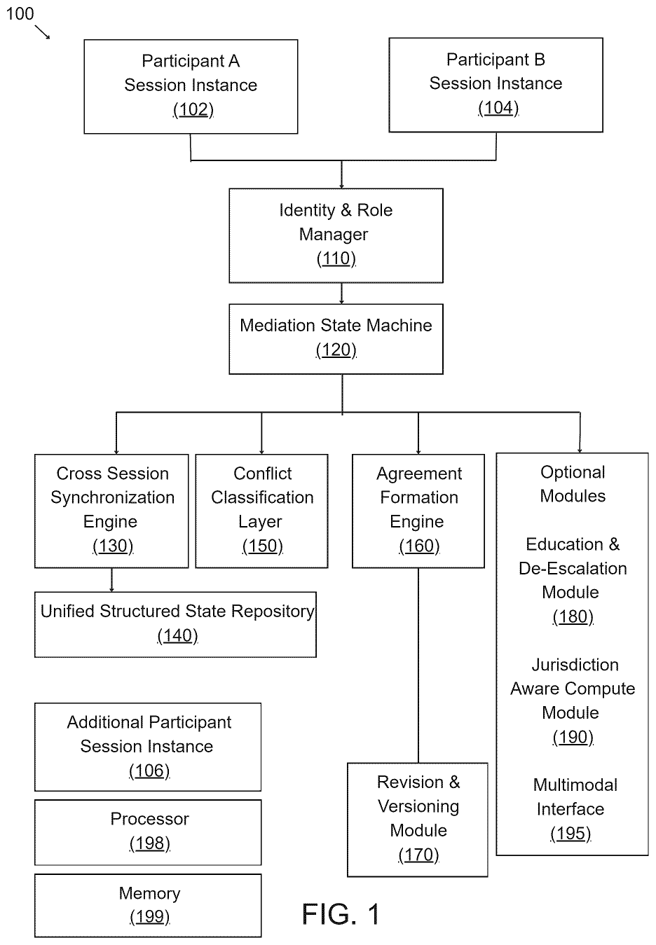

Referring to FIG. 1, a multi-party conflict resolution system 100 is illustrated. The system 100 comprises a plurality of participant session instances, including a first participant session instance 102 and a second participant session instance 104. In certain embodiments, additional participant session instances 106 may also be supported.

Each session instance communicates with an identity and role manager 110, which resolves participant identity, role assignment, and access permissions. The identity and role manager 110 interfaces with a mediation state machine 120 that governs structured progression of the conflict resolution process.

The mediation state machine 120 is operatively connected to a cross-session synchronization engine 130 and a unified structured state repository 140. The synchronization engine 130 selectively synchronizes structured abstractions derived from participant communications while maintaining isolation of raw participant communications within their respective session instances.

A conflict classification layer 150 classifies issues and dispute states. An agreement formation engine 160 generates structured agreement objects upon satisfaction of defined consent conditions. A revision and versioning module 170 enables reopening and modification of previously resolved issues. Optional modules may include an education and de-escalation module 180, a jurisdiction-aware computation module 190, and a multimodal interface layer 195.

In this architecture, each participant communicates independently with the system 100 through a session instance. Although session instances 102 and 104 remain logically isolated, they are structurally coordinated through the mediation state machine 120 and the unified structured state repository 140.

Each participant session instance, such as session 102 or 104 shown in FIG. 1, is configured to receive communications from a distinct participant. Upon session initiation, the identity and role manager 110 assigns a unique identity token and associates the participant with role metadata, such as parent, employee, employer, buyer, seller, or other defined roles. The identity and role manager 110 further enforces access permissions governing what structured information may be viewed or modified.

Session instances may operate asynchronously or synchronously. Communications may be received in text form, audio form, video form, or through the multimodal interface layer 195. Regardless of format, incoming communications are processed within the respective session instance and are not directly transmitted to other participants.

Raw participant messages remain confined to their originating session instance. Structured abstractions derived from those messages may be transmitted through the cross-session synchronization engine 130, as described below.

The unified structured state repository 140 stores structured representations of the mediation process. These structured representations may include issue identifiers, participant positions, classification labels, agreement status, revision history, consent confirmations, timestamps, and structured summaries.

The repository 140 may be implemented using graph databases, relational databases, document-based storage systems, distributed memory architectures, or hybrid persistence mechanisms. The specific storage technology does not limit the invention.

The cross-session synchronization engine 130 updates the unified structured state repository 140 upon occurrence of defined synchronization events. Such events may include receipt of new structured data, detection of a state transition within the mediation state machine 120, satisfaction of consent conditions, or scheduled synchronization intervals.

Importantly, only structured abstractions are stored in and retrieved from the repository 140 for cross-session purposes. Raw communications are not stored in a manner that permits direct cross-participant exposure.

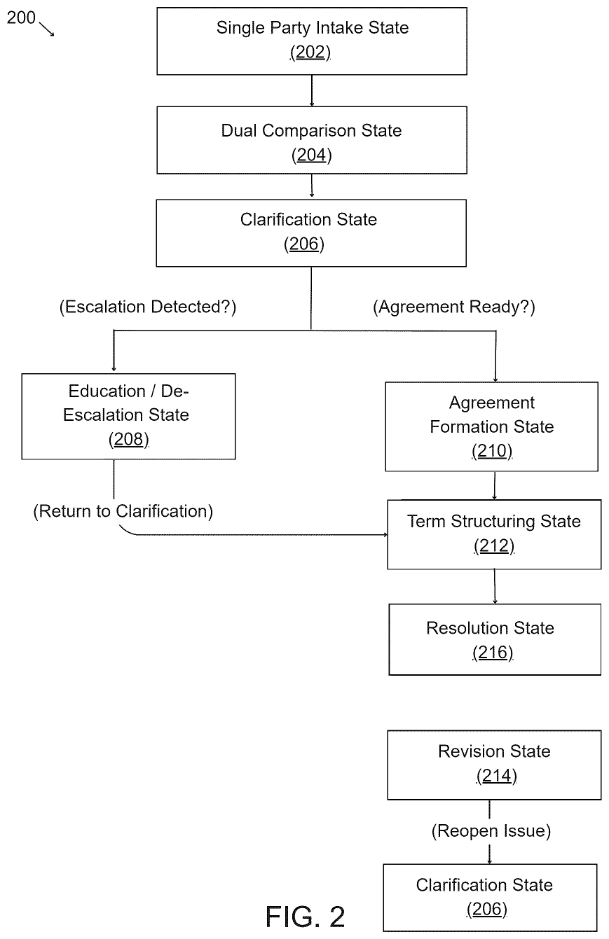

Referring additionally to FIG. 2, the mediation state machine 120 governs progression of the conflict resolution process through structured states 200. These states may include a single-party intake state 202, a dual comparison state 204, a clarification state 206, an education or de-escalation state 208, an agreement formation state 210, a term structuring state 212, a revision state 214, and a resolution state 216.

Transitions between states may be triggered by predefined rules, issue classification results generated by the conflict classification layer 150, explicit participant consent, mediator-defined conditions, or participant-initiated revision requests. The mediation state machine 120 prevents premature agreement formation by requiring defined transitions before entering the agreement formation state 210.

Where a revision trigger is detected, the revision state 214 may route the process back to the clarification state 206, thereby enabling structured re-evaluation of previously addressed issues.

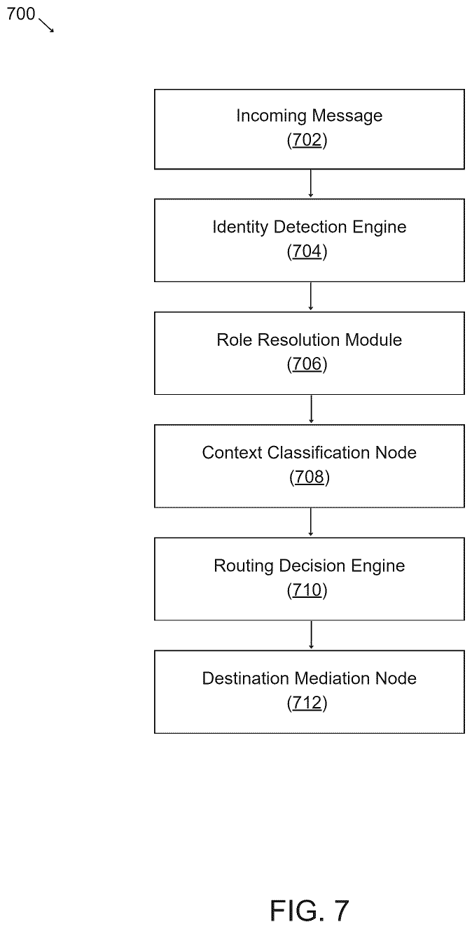

Referring to FIG. 7, incoming participant communications 702 are processed by an identity detection engine 704 and a role resolution module 706. These components determine the participant's identity and role context before routing the communication to an appropriate mediation node 712 via a routing decision engine 710.

Routing decisions may consider participant identity, assigned role, issue domain, escalation level, and consent status. This identity-aware routing prevents misattribution of communications, preserves role distinctions, and ensures that confidential inputs remain segregated unless abstracted and authorized for synchronization.

By integrating identity-aware routing with the mediation state machine 120 and synchronization engine 130, the system maintains structural integrity across independent participant sessions while enabling coordinated progression toward agreement formation.

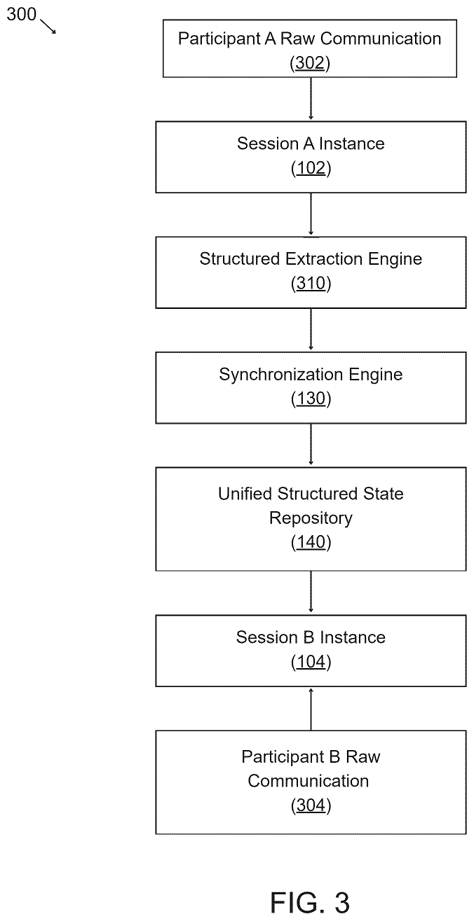

As illustrated in FIG. 3, cross-session synchronization is performed through the Synchronization Engine 130 in coordination with the Unified Structured State Repository 140. Each participant communicates through a distinct session instance, such as Session A 102 and Session B 104. Raw participant communications, including Participant A Raw Communication 302 and Participant B Raw Communication 304, remain isolated within their respective session instances and are not directly exchanged between participants.

Instead of transmitting raw messages, the system extracts structured representations through a Structured Extraction Engine 310. These structured representations are stored in the Unified Structured State Repository 140 and may include extracted position statements, issue categorizations, agreement classifications, summarized proposals, and structured conflict markers. In certain embodiments, the Synchronization Engine 130 performs bidirectional validation prior to propagation of structured abstractions to ensure state consistency. The structured data is abstracted to remove conversational volatility while preserving substantive meaning relevant to conflict resolution. The abstraction process may include structured field extraction, token normalization, semantic classification, and rule-based filtering to generate machine-processable representations stored within the Unified Structured State Repository 140.

The Synchronization Engine 130 selectively transmits only structured abstractions between session instances. This selective synchronization ensures that each participant receives a mediated representation of the other participant's position without exposure to unfiltered language, tone, or potentially escalatory phrasing.

In certain embodiments, the system intentionally excludes specific categories of content from synchronization. These exclusions may include emotional language, sensitive disclosures, privileged content, and information provided without consent for sharing. The exclusion rules may be governed by participant role, classification state, consent conditions, or escalation status as determined by the Mediation State Machine 120 and Conflict Classification Layer 150.

By synchronizing structured abstractions rather than raw communications, the system maintains functional awareness across session instances while reducing the likelihood of escalation. This architecture distinguishes the invention from conventional group communication systems in which participants directly view one another's unmediated messages.

As illustrated in FIG. 1, the system 100 includes a conflict classification layer 150 configured to analyze structured issue representations stored in the unified state repository 140. The conflict classification layer 150 operates in coordination with the mediation state machine 120 to determine the procedural posture of each issue under discussion.

In one embodiment, each issue is categorized into one of several structured classifications, including agreement, partial agreement, clarification required, substantive disagreement, or escalated conflict. These classifications are stored in the unified state repository 140 and are used by the mediation state machine 120 to control state transitions, including transitions between the dual comparison state (204), clarification state (206), and agreement formation state (210), as illustrated in FIG. 2.

Classification may be performed using rule-based logic, machine learning models, hybrid decision systems, or combinations thereof. In certain embodiments, the conflict classification layer (150) may analyze structured position data extracted by the structured extraction engine (310) shown in FIG. 3. In other embodiments, classification may incorporate historical interaction data stored within the unified state repository (140).

The system may further include escalation detection logic configured to identify conflict intensification conditions. Such conditions may include repeated disagreement on a single issue, conflicting structured inputs across sessions (102, 104), or detection of escalation indicators within participant communications. Upon detection of escalation beyond a predefined threshold, the mediation state machine (120) may transition the process to the education and de-escalation state (208), as shown in FIG. 2.

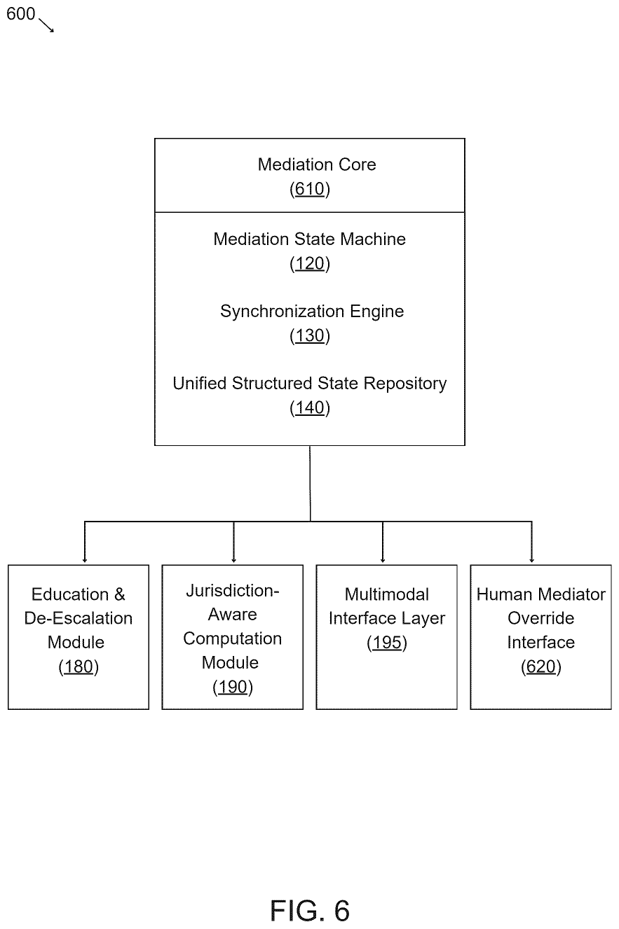

In response to escalation detection, the education and de-escalation module (180), illustrated in FIG. 6, may be activated. The module (180) may insert contextual educational content, structured reframing prompts, or cooling-off delays prior to further agreement progression. In certain embodiments, the system may route the matter to a human mediator override interface (620) for review.

Escalation thresholds and classification parameters may be configurable, dynamically learned, or jurisdiction-specific. In all embodiments, classification outcomes are persisted in the unified state repository (140), thereby preserving auditability and enabling structured progression through the mediation workflow.

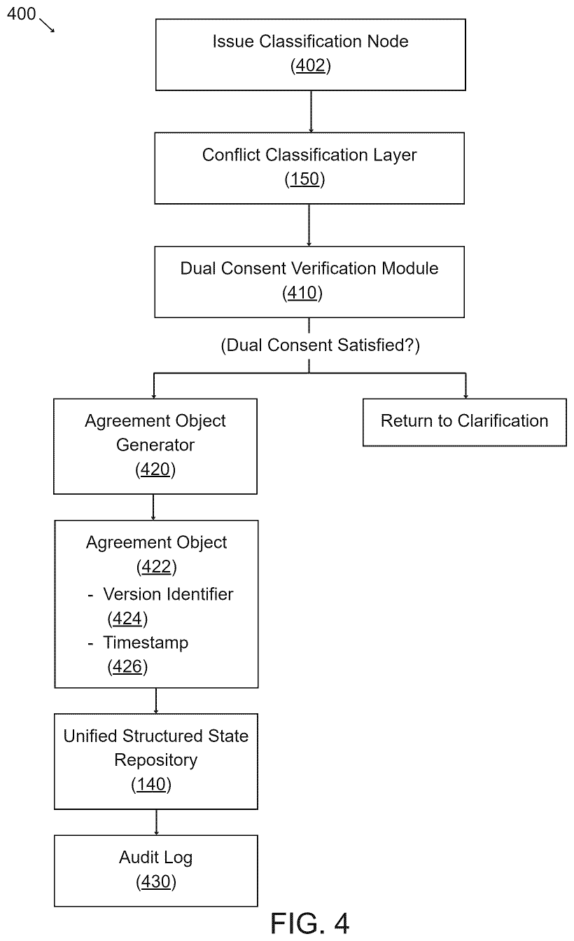

Agreement formation within the disclosed system is governed by the Agreement Formation Engine (160) in coordination with the Dual Consent Verification Module (410), as illustrated in FIG. 4.

When one or more issues have been classified by the Conflict Classification Layer (150) and are determined to be eligible for resolution, the system transitions to an agreement formation state (210) of the Mediation State Machine (120). At this stage, the Dual Consent Verification Module (410) is invoked to confirm that all required participants associated with the issue have provided explicit confirmation of the proposed terms.

Each participant confirmation is recorded within the Unified Structured State Repository (140) and associated with a corresponding issue identifier. The system requires that all required participants affirmatively confirm the proposed resolution before an agreement object is generated. In certain embodiments, explicit confirmation prompts are delivered to the respective Participant Session Instances (102, 104) through the Identity and Role Manager (110), ensuring that confirmations are attributable to the correct participant identity.

Upon successful verification of dual consent, the Agreement Object Generator (420) produces an Agreement Object (422). The Agreement Object (422) includes structured metadata comprising an issue identifier, participant confirmations, a timestamp (426), and a version identifier (424). The Agreement Object (422) is then stored within the Unified Structured State Repository (140), and a corresponding entry is recorded in the Audit Log (430).

The system is configured such that an agreement is not finalized unless:
(1) all required participant confirmations are recorded,
(2) consent validation conditions enforced by the Dual Consent Verification Module (410) are satisfied; and
(3) state integrity checks confirm consistency within the Unified Structured State Repository (140).

State integrity validation may include verifying that no unresolved conflicts remain for the issue, that no pending revision requests exist, and that synchronization events between session instances are complete.

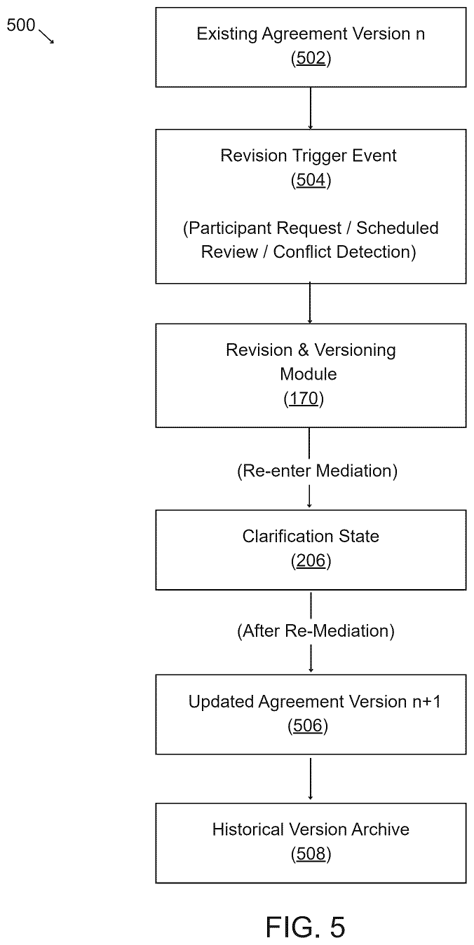

In certain embodiments, Agreement Objects (422) are configured to support subsequent modification rights and revision triggers. As illustrated in FIG. 5, a Revision Trigger Event (504) may initiate the Revision Module (170), resulting in generation of an Updated Agreement Version (506) while preserving the prior version (502) in a Historical Version Archive (508). Each subsequent version maintains its own version identifier (424) and timestamp (426), thereby enabling traceable version control and auditability.

Through this structured consent gating and agreement formation architecture, the system ensures that agreements are formed through verified, state-controlled mediation rather than uncontrolled direct participant negotiation.

In certain embodiments, the multi-party conflict resolution system (100) further includes a Revision and Versioning Module (170), as illustrated in FIG. 5. The Revision and Versioning Module (170) enables structured modification of previously formed agreement objects (422) without disrupting overall system state integrity.

As shown in FIG. 5, an existing agreement version (502) may be associated with a revision trigger event (504). The revision trigger event (504) may be initiated by a participant request, detection of changed circumstances, scheduled review intervals, or mediator-driven intervention. Upon detection of the revision trigger event (504), the Revision Module (170) generates a new revision instance corresponding to a subsequent agreement version (506).

In some embodiments, the system routes the revision workflow back into the mediation state machine (120), specifically re-entering the Clarification State (206) illustrated in FIG. 2. This structured re-entry ensures that modifications occur through the same controlled progression used for initial agreement formation, rather than through ad hoc amendment.

The Revision Module (170) may require dual consent verification through the Dual Consent Verification Module (410), illustrated in FIG. 4, prior to finalizing an updated agreement version (506). In certain embodiments, the system may require structured re-mediation steps, additional clarification exchanges, or scheduling of follow-up sessions before a revised agreement is confirmed.

Each agreement version, including the original agreement object (422) and any subsequent versions (506), may be stored in a Historical Version Archive (508) within or associated with the Unified Structured State Repository (140). The Historical Version Archive (508) preserves prior versions for auditability, traceability, and historical reference. Version identifiers (424) and timestamps (426), as shown in FIG. 4, may be associated with each stored agreement instance.

In some embodiments, the system enables comparison between prior agreement versions (502) and updated versions (506), including structured diff analysis, term-level modification tracking, and revision logs linked to session interactions. The revision logs may be associated with participant session instances (102, 104) while maintaining isolation of raw communications consistent with the cross-session synchronization model illustrated in FIG. 3.

Through this architecture, the system treats agreements as dynamic, version-controlled artifacts rather than static endpoints, enabling structured evolution of negotiated outcomes while preserving audit integrity and state continuity.

In certain embodiments, the system (100) includes an education and de-escalation module (180), as illustrated in FIGS. 1 and 6. The education and de-escalation module (180) operates in coordination with the mediation state machine (120) and the conflict classification layer (150) to reduce escalation and improve structured agreement formation.

During operation, incoming participant communications received at session instances (102, 104) may be evaluated by the conflict classification layer (150) to identify indicators of friction, misunderstanding, or escalation. Such indicators may include, without limitation, sentiment analysis outputs, repeated disagreement classifications, abrupt state regressions, emotionally charged language patterns, or issue categories associated with historically elevated conflict rates.

Upon detection of a triggering condition, the mediation state machine (120) may transition from a clarification state (206) to an education or de-escalation state (208), as depicted in FIG. 2. In this state, the education and de-escalation module (180) may generate or select contextual guidance, structured explanations, calming prompts, reframing suggestions, or neutral educational content relevant to the identified issue. The selected intervention may be inserted into the participant's session instance (102 or 104) through the Identity & Role Manager (110) and Routing Decision Engine (710) as illustrated in FIG. 7, ensuring that the content is tailored to the participant's role and current mediation context. In some embodiments, the module (180) may generate distinct but contextually aligned interventions for multiple participants while maintaining session isolation.

The education and de-escalation module (180) may further track the effectiveness of interventions by monitoring subsequent issue classifications, sentiment changes, or progression within the mediation state machine (120). If escalation indicators persist, the system may maintain the education state (208), introduce additional interventions, delay advancement to agreement formation (210), or escalate to human mediator review via interface (620), as shown in FIG. 6.

In this manner, the education and de-escalation module (180) functions not merely as content delivery, but as a control mechanism influencing state transitions within the structured mediation process. The module thereby contributes to controlled synchronization, reduced adversarial escalation, and improved stability of agreement formation.

In certain embodiments, the multi-party conflict resolution system (100) further includes a jurisdiction-aware computation module (190), as illustrated in FIG. 6. The jurisdiction-aware computation module (190) interfaces with the mediation core (610), including the mediation state machine (120) and the unified structured state repository (140), to incorporate rule-based or policy-based calculations into the structured conflict resolution workflow.

The jurisdiction-aware computation module (190) may be configured to process jurisdiction-specific frameworks, including financial support calculations, statutory rule sets, regulatory policy structures, or other structured decision schemas. The module may identify a governing jurisdiction based on participant input, stored metadata, or contextual parameters maintained within the unified structured state repository (140).

Upon receiving structured inputs from one or more participant session instances (102, 104), the jurisdiction-aware computation module (190) may normalize data fields to ensure consistency across differing rule systems. The module may then execute one or more calculation routines corresponding to the identified jurisdiction. In some embodiments, the module maintains a provenance record identifying the source of the governing rule set, version of the calculation framework, and timestamp of execution, which may be stored within the unified structured state repository (140).

Computed outputs generated by the jurisdiction-aware computation module (190) may be provided in an explainable format, including a breakdown of factors, assumptions, or rule applications. These outputs may be introduced into the mediation workflow under control of the mediation state machine (120), such that participants are presented with structured information without requiring the system to mandate a particular outcome.

In certain embodiments, participants may override or deviate from computed outputs through the agreement formation engine (160), subject to dual consent verification (410) as described in connection with FIG. 4. The resulting negotiated terms, whether aligned with or deviating from computed outputs, may be stored as agreement objects (422) within the unified structured state repository (140), including version identifiers (424) and associated audit logs (430).

The jurisdiction-aware computation module (190) may be implemented as an in-house computational engine, a third-party integrated service, or a hybrid architecture combining both internal and external rule-processing components. The invention is not limited to any specific jurisdiction, rule set, or calculation type, and the computation module (190) may support legal, financial, regulatory, commercial, or policy-based frameworks.

By integrating jurisdiction-aware computation into the structured mediation architecture, the system preserves identity-aware routing, selective cross-session synchronization, and controlled agreement formation while enhancing transparency and explainability in conflict resolution contexts.

In certain embodiments, the multi-party conflict resolution system (100) supports interaction across multiple communication modalities while preserving structured state continuity. As illustrated in FIG. 1 and FIG. 6, the system may include a multimodal interface layer (195) configured to receive participant communications in text, audio, video, or mixed-mode formats.

Participant communications received in audio or video form may be processed through speech-to-text conversion components prior to structured extraction by the synchronization engine (130). Conversely, system-generated responses may be rendered through text-to-speech or visual presentation modules while maintaining routing through the Identity & Role Manager (110). Regardless of input modality, extracted structured position data is stored within the unified structured state repository (140) and processed by the mediation state machine (120) in a modality-independent manner.

In this way, the mediation state machine (120) operates on structured representations of participant inputs rather than raw modality-specific data streams. The cross-session synchronization engine (130) continues to selectively synchronize abstracted issue representations across participant session instances (102, 104) without exposing raw communications, even where such communications originate from audio or video sources.

State integrity, participant identity, and consent tracking are preserved across modality transitions. For example, a participant may initiate mediation in text format and later continue in audio format without disrupting state continuity, agreement versioning (FIG. 5), or consent gating (FIG. 4). The system maintains consistent participant identification through the identity detection engine (704) illustrated in FIG. 7, ensuring that modality changes do not result in misattribution or identity confusion.

In mixed-mode embodiments, one participant may interact through text while another interacts through audio or video. The multimodal interface layer (195) normalizes inputs into structured representations prior to processing by the mediation state machine (120). This architecture ensures that mediation logic, synchronization rules, and agreement formation mechanisms remain consistent irrespective of communication modality.

Accordingly, multimodal capability is implemented as an interface-level abstraction layered above the structured state architecture, rather than as a separate mediation system. This design preserves functional continuity, auditability, and enforceability of agreement objects across all supported interaction formats.

The multi-party conflict resolution system (100) is configured to detect, manage, and recover from operational and participant-driven failure conditions while preserving mediation integrity and state consistency.

In certain embodiments, failure conditions may include interruption of one or more participant session instances (102, 104, 106), asymmetric participation between participants, participant withdrawal, stale or outdated structured state data stored in the unified structured state repository (140), conflicting structured inputs extracted by the structured extraction engine (310), or temporary unavailability of computational resources associated with processor (198) or memory (199).

When a session interruption occurs, the mediation state machine (120) may suspend advancement of the mediation process and maintain the current mediation state within the mediation state machine (120) without loss of structured issue data. Upon reconnection, the identity and role manager (110) may re-authenticate the participant and restore session continuity using stored state information within the unified structured state repository (140).

In cases of asymmetric participation, where one participant continues to provide inputs while another participant becomes inactive, the mediation state machine (120) may prevent unilateral agreement formation by requiring dual consent verification through the dual consent verification module (410) prior to generation of an agreement object (422). The system thereby enforces structural fairness and prevents premature resolution.

When conflicting structured inputs are detected by the conflict classification layer (150), the mediation state machine (120) may automatically transition to the clarification state (206) as illustrated in FIG. 2. The cross-session synchronization engine (130) may generate abstracted summaries that isolate areas of inconsistency without exposing raw communications (302, 304), thereby enabling controlled re-alignment of participant positions.

In embodiments involving stale or outdated data within the unified structured state repository (140), the system may perform state validation checks prior to agreement formation. If inconsistencies are detected, the agreement formation engine (160) may suspend generation of an agreement object (422) until integrity is restored.

Where a participant initiates withdrawal during an active mediation process, the mediation state machine (120) may transition to a paused condition and preserve all versioned agreement artifacts, including existing agreement version (502) and historical versions stored within archive (508). The system may allow later re-entry into the revision state (214) or clarification state (206), depending on context.

In the event of system downtime or infrastructure interruption, synchronization checkpoints may be stored within the unified structured state repository (140). Upon restoration, the cross-session synchronization engine (130) may execute a re-synchronization event to validate consistency between participant session instances (102, 104, 106) and the mediation core (610).

In certain embodiments, automatic pause conditions may be triggered upon detection of escalation thresholds identified by the conflict classification layer (150) or de-escalation module (180). The mediation state machine (120) may temporarily halt progression to prevent unstable agreement formation.

Through these mechanisms, the system maintains structural integrity, identity continuity, agreement validity, and audit consistency even under conditions of interruption, withdrawal, conflict escalation, or infrastructure instability.

The multi-party conflict resolution system (100) described in FIG. 1 is not limited to any particular subject matter domain. The architectural components, including the mediation state machine (120), cross-session synchronization engine (130), unified structured state repository (140), and agreement formation engine (160), are configured to operate across a wide range of dispute-resolution and structured negotiation environments.

In certain embodiments, the system may be applied to legal contexts. For example, in co-parenting mediation, participant session instances (102, 104) may correspond to separated parents negotiating physical custody arrangements, decision-making authority, scheduling, financial support obligations, or modification of existing parenting terms. The mediation state machine (120), illustrated in FIG. 2, governs structured progression through intake, comparison, clarification, agreement formation, and revision states. The revision module (170), shown in FIG. 5, enables re-opening and structured modification of previously resolved parenting terms.

In divorce or financial structuring scenarios, the jurisdiction-aware computation module (190), depicted in FIG. 6, may integrate rule-based calculations, such as financial support determinations, into the mediation workflow. Outputs from such computation modules are stored within the unified state repository (140) and incorporated into agreement objects generated by the agreement formation engine (160).

The system may also be applied to contract disputes or settlement negotiations. In such embodiments, participants may represent counterparties in a commercial disagreement. The cross-session synchronization engine (130), illustrated in FIG. 3, selectively abstracts and synchronizes structured issue representations without permitting direct exchange of raw communications. This prevents escalation while preserving structured awareness.

Workplace grievances and employment disputes may likewise be mediated through the architecture shown in FIG. 1. Participants may include employees, supervisors, human resources representatives, or organizational stakeholders. The conflict classification layer (150) categorizes issues and triggers structured clarification or de-escalation states (208) within the mediation state machine (120).

In non-legal contexts, the system may facilitate business negotiations, vendor-client disputes, professional partnership conflicts, community mediation, or therapeutic structured communication. In these embodiments, the same Identity & Role Manager (110) and structured state transitions operate independently of legal rule sets. The architecture remains unchanged; only the subject matter of the issues differs.

Because the system relies on structured state synchronization rather than domain-specific logic, the architecture is domain-agnostic and adaptable. The components described in FIGS. 1-7 may be configured for any context in which two or more participants require structured, mediated coordination without direct confrontation.

The multi-party conflict resolution system (100) described herein, including the architectural components illustrated in FIGS. 1-6, may be implemented in a variety of computing environments without departing from the structural principles of the invention.

In certain embodiments, the system (100) is deployed as a cloud-based architecture in which the processor (198), memory (199), unified structured state repository (140), and synchronization engine (130) are hosted on remote computing infrastructure accessible through networked devices. In such embodiments, participant session instances (102, 104, 106) may execute through web interfaces, mobile applications, or secure browser-based portals while maintaining centralized mediation state control.

In other embodiments, the system may operate as a distributed system in which one or more components of the mediation core, including the mediation state machine (120) and Identity & Role Manager (110), execute across multiple computing nodes. The unified structured state repository (140) may be replicated or sharded across distributed storage systems, provided that synchronization integrity is preserved.

In enterprise-deployed embodiments, the system may be installed within a private organizational environment, including corporate, governmental, or institutional networks. In such configurations, modules illustrated in FIG. 6, including the jurisdiction-aware computation module (190) or education module (180), may integrate with enterprise data systems, authentication services, or compliance frameworks.

In hybrid embodiments, the system may function as a human-AI collaborative mediation tool. A human mediator may interact with the mediation core (610) or override interface (620) while the system maintains structured state management, synchronization logic, agreement formation control, and revision tracking. The human mediator may supervise, approve, or modify state transitions without disrupting architectural integrity.

In consumer-facing embodiments, the system may be delivered as a direct-to-user application in which the participant session instances (102, 104) are accessed through mobile devices, personal computers, or integrated communication platforms. The structural mediation logic remains consistent regardless of presentation layer.

Across all embodiments, programming languages, artificial intelligence models, database technologies, hosting environments, and communication protocols may vary. The invention is not limited to any specific machine learning model, natural language processing framework, storage architecture, or deployment configuration. Substitution of computational components, hosting providers, or implementation technologies does not alter the core structural features defined by the mediation state machine (120), cross-session synchronization engine (130), unified state repository (140), and identity-aware routing architecture (110).

As illustrated in FIG. 1, the disclosed system (100) provides a structured, state-synchronized, identity-aware architecture for multi-party conflict resolution. Independent participant session instances (102, 104, 106) are coordinated through a cross-session synchronization engine (130) and a unified structured state repository (140), while remaining isolated from direct participant-to-participant communication. This architectural separation allows structured abstraction and controlled information exchange without exposing raw communications.

The mediation state machine (120), further illustrated in FIG. 2, governs progression through defined states including intake, comparison, clarification, agreement formation, revision, and resolution. These state transitions enable orderly advancement toward agreement while preserving procedural safeguards such as consent gating and conflict classification. The agreement formation and consent verification mechanisms described with reference to FIG. 4 ensure that agreement objects (422) are generated only upon appropriate confirmation and are stored with version identifiers (424) and audit records (430).

As shown in FIG. 3 and FIG. 5, synchronization and revision mechanisms permit structured comparison of participant positions and controlled re-entry into mediation states when previously resolved issues are reopened. This allows agreement artifacts to function as versioned, living records rather than static outputs.

The architecture further supports modular extensions, as illustrated in FIG. 6, including education and de-escalation modules (180), jurisdiction-aware computational modules (190), and multimodal interface layers (195). These modules operate in coordination with the mediation core (610) while preserving the identity-aware routing and state integrity described herein.

Accordingly, the invention provides a scalable and extensible conflict resolution framework applicable to legal and non-legal contexts, including co-parenting mediation, commercial negotiations, workplace disputes, and structured interpersonal communication. By combining isolated participant sessions with controlled synchronization, structured state transitions, and agreement formation logic, the system enables mediated resolution without requiring direct confrontation between participants. It will be appreciated that the embodiments of the invention are not to be limited to the specific embodiments disclosed and that modifications and other embodiments are intended to be included within the scope of the appended claims. Although specific terms are used herein, they are used in a generic and descriptive sense only, and not for purposes of limitation.

Generally speaking, various example embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in flowcharts may be viewed as method steps, and/or as operations that result from the operation of computer program code, and/or as a plurality of coupled logic circuit elements constructed to carry out the associated function(s). For example, embodiments of the present invention include a computer program product comprising a computer program tangibly embodied on a machine readable medium, the computer program containing program codes configured to carry out the methods as described above.

In the context of the disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present invention may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may be executed entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. Further, it is well known to the skilled person that communication media typically embodies computer readable instructions, data structures, program modules or other data in a modulated data signal such as a carrier wave or other transport mechanism and includes any information delivery media.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications and adaptations to the foregoing example embodiments of this invention may become apparent to those skilled in the relevant arts in view of the foregoing description, when it is read in conjunction with the accompanying drawings. Any and all modifications will still fall within the scope of the non-limiting and example embodiments of this invention. Furthermore, other embodiments of the inventions category forth herein will come to mind to one skilled in the art to which these embodiments of the invention pertain having the benefit of the teachings presented in the foregoing descriptions and the drawings.

What is claimed is:

1. A computer-implemented multi-party conflict resolution system comprising:
a processor;
a memory storing executable instructions;
a plurality of participant session instances, each session instance configured to receive communications from a distinct participant;
a unified structured state repository configured to store abstracted representations of participant positions, issue classifications, consent states, and agreement status, version identifiers, revision metadata, and audit records;
a cross-session synchronization engine configured to selectively synchronize structured representations between the plurality of participant session instances without exposing raw participant communications;
an identity-aware routing engine configured to route communications and system-generated responses based on participant identity and assigned role; and
a mediation state machine configured to control structured progression of a conflict resolution process through a plurality of predefined states and to enforce consent conditions prior to agreement generation,
wherein the system enables formation of agreements between the distinct participants without requiring direct participant-to-participant communication.

2. The system of claim 1, wherein the mediation state machine includes states comprising single-party intake, dual comparison, clarification, agreement formation, revision, and resolution.

3. The system of claim 1, wherein the identity and role manager prevents misattribution of communications between participants.

4. The system of claim 1, wherein routing decisions are based on one or more of participant identity, assigned role, issue classification, and escalation status.

5. The system of claim 1, wherein agreement formation requires dual consent verification from the plurality of participants.

6. The system of claim 1, wherein agreement formation requires dual consent verification from the plurality of participants.

7. The system of claim 1, wherein synchronization occurs upon detection of state transition events.

8. The system of claim 1, further comprising a conflict classification layer configured to categorize issues as agreement, partial agreement, clarification required, or disagreement.

9. The system of claim 1, wherein the agreement object includes a version identifier and timestamp.

10. The system of claim 1, further comprising a revision module configured to reopen a previously resolved issue and generate a subsequent version of the agreement object.

11. The system of claim 1, further comprising a jurisdiction-aware computation module configured to integrate rule-based calculations into the mediation process.

12. The system of claim 1, further comprising an education module configured to insert contextual guidance based on detected escalation conditions.

13. The system of claim 1, wherein communications are received in at least one of text, audio, or video formats while preserving structured state continuity.

14. The system of claim 1, wherein the plurality of participant session instances includes more than two participants.

15. A computer-implemented method for structured multi-party conflict resolution, comprising:
receiving, at a first session instance, a first communication from a first participant;
extracting structured position data from the first communication;
storing the structured position data in a unified state repository;
receiving, at a second session instance, a second communication from a second participant;
extracting structured position data from the second communication;
classifying one or more issues based on the structured position data;
selectively synchronizing abstracted representations of the structured position data between the first and second session instances;
controlling progression of a mediation process using a mediation state machine; and
forming an agreement object upon verification of defined consent conditions enforced by the mediation state machine,
wherein the participants do not directly exchange raw communications.

16. The method of claim 15, further comprising transitioning between mediation states based on one or more of issue classification and participant confirmation.

17. The method of claim 15, further comprising requiring explicit confirmation from each participant prior to generating the agreement object.

18. The method of claim 15, further comprising detecting escalation indicators and initiating a de-escalation intervention.

19. The method of claim 15, further comprising storing prior agreement versions in an audit log.

20. A non-transitory computer readable medium comprising instructions that when executed by a processor cause the processor to perform a structured multi-party conflict resolution method, the method comprising:
receiving, at a first session instance, a first communication from a first participant;
extracting structured position data from the first communication;
storing the structured position data in a unified state repository;
receiving, at a second session instance, a second communication from a second participant;
extracting structured position data from the second communication;
classifying one or more issues based on the structured position data;
selectively synchronizing abstracted representations of the structured position data between the first and second session instances;
controlling progression of a mediation process using a mediation state machine; and
forming an agreement object upon verification of defined consent conditions enforced by the mediation state machine,
wherein the participants do not directly exchange raw communications.
